(19) United States
(12) Patent Application Publication
(10) Pub. No.: US 2007/0208558 A1
(43) Pub. Date: Sep. 6, 2007

(54) System and Method for Measuring Sound

(76) Inventor: Carlos Eduardo Carvalho de Matos, Salvador BA (BR)

Correspondence Address: COOLEY GODWARD KRONISH LLP;ATTN: Patent Group, Suite 500, 1200 - 19th Street, NW, WASHINGTON, DC, 20036-2402, US

(21) Appl. No.: 11/469,549

(22) Filed: Sep. 1, 2006

Related U.S. Application Data
(60) Provisional application No. 60/714,005, filed on Sep. 2, 2005.

(51) Int. Cl. G10L 21/02

(52) U.S. Cl. 704/226

(57) ABSTRACT

A system and method for measuring sound is described. In one embodiment frequency-banded-noise samples, which collectively cover at least a portion of a spectrum, are sequentially generated at different points in time, and a baseline sound-pressure-level reading for each of the frequency banded noise samples is received. Using data received from a microphone, a sound pressure level reading is generated for each of the frequency banded noise samples. Calibration data is then produced for the microphone as a function of a difference between each of the baseline sound-pressure-level readings and a corresponding one of each of the generated sound pressure level readings for each of the frequency banded noise samples.

### PRIORITY

The present application claims priority to commonly owned and assigned application No. 60/714,005, filed Sep. 2, 2005, attorney docket No. MATO-001/00US, entitled System and Method for Measuring Sound, which is incorporated herein by reference.

### FIELD OF THE INVENTION

This invention relates generally to sound measurement, and more particularly to systems and methods for improved sound measurement.

### BACKGROUND

There are several known disorders that adversely affect the speech of many people. For example, Parkinson disease (PD) multiple sclerosis, strokes, ataxic dysarthria, aging voice, and vocal fold paralysis impact the speech of many persons. Traditional neuropharmacological and neurosurgical treatments have been of limited help in improving these problems with conventional wisdom being that speech disorders are resistant to medical treatments and efforts at traditional speech therapy have been considered ineffective.

The landscape, however, has changed recently, and experimental data from a focused program of specialized speech therapy has been shown to provide significant benefits, which may include improved speech intelligibility, motor functions and neural functioning. These treatment effects have been shown to be relatively long lasting without additional treatment and have been considered the first Type 1 evidence for speech treatment for PD.

Speech treatment is an immediate, practical, and relatively inexpensive intervention for improving behavior. There is no requirement for FDA regulation, and an efficacious treatment is available, easily delivered and highly acceptable to patients with minimal, if any, negative side effects.

Speech treatment may be effectively carried out in a clinical setting with sophisticated hardware and speech analysis equipment. But these clinical locations may be inconvenient, unavailable and/or too expensive for many patients to take advantage of. Although microphones and rudimentary speech analysis software are available, typical consumer-grade microphones are currently not able to accurately measure one or more important characteristics of the user's voice. For example, measurements of the sound pressure level and fundamental frequency of a user's voice are often too inaccurate with many affordable microphones to provide the type of analysis desired for speech therapy purposes.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention can provide a system and method for measuring sound. In one embodiment, frequency-banded-noise samples, which collectively cover at least a portion of a spectrum, are sequentially generated at different points in time, and a baseline sound-pressure-level reading for each of the frequency banded noise samples is received. Using data received from a microphone, a sound pressure level reading is generated for each of the frequency banded noise samples. Calibration data is then produced for the microphone as a function of a difference between each of the baseline sound-pressure-level readings and a corresponding one of each of the generated sound pressure level readings for each of the frequency banded noise samples.

### DETAILED DESCRIPTION

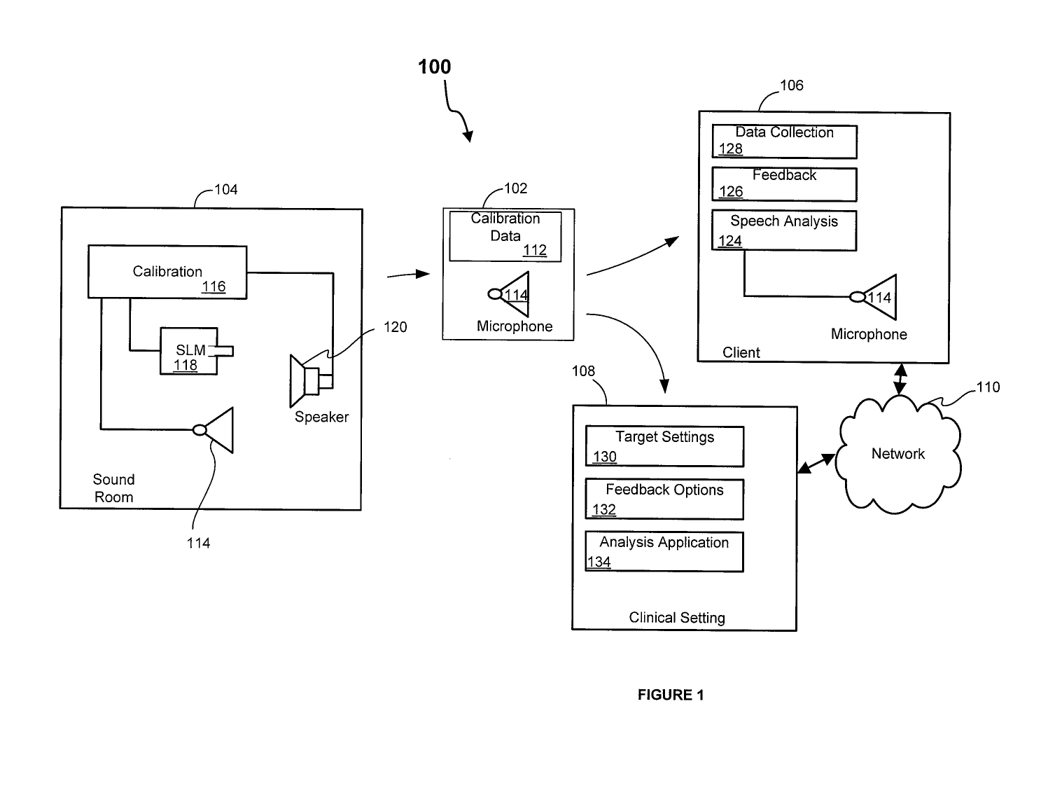

Referring now to the drawings, where like or similar elements are designated with identical reference numerals throughout the several views, and referring to FIG. 1, shown is a block diagram depicting an exemplary environment 100 in which embodiments of the present invention may be implemented. As shown in the embodiment depicted in FIG. 1, a calibration data and microphone package 102 is provided from a sound room 104 to a client location 106. In addition, a clinic 108 is shown in communication with the client 106 via a network 110.

In accordance with several embodiments of the present invention, a calibration procedure carried out at the sound room 104 generates calibration data 112 for the microphone 114 that enables the microphone 114 to be utilized for purposes that the microphone 114 was previously unsuitable for. As depicted in FIG. 1 the calibration data 112 is provided to the client 106 along with the microphone 114 to enable a user to accurately measure characteristics of the user's voice. In some embodiments, for example, the calibration data 112 enables the microphone 114 to be used in connection with accurate measurements of the sound pressure level and fundamental frequency of a user's voice that would not be achievable with the microphone 114 (e.g., because of its low quality) without the calibration data 112.

Although several embodiments of the present invention are described in the context of transducing audible sound in a speech therapy setting, it should be recognized that the calibration and sound capturing procedures of the present invention are certainly not limited to these applications. For example, it is contemplated that the accurate measurements that the calibration data 112 provides may be used in a variety of applications where, for example, sound pressure level and/or fundamental frequency readings are desired.

As depicted in FIG. 1, the sound room 104 includes a calibration module 116 coupled to a sound level meter 118, a speaker 120 and a microphone 114. The calibration module 116 in the exemplary embodiment is configured to calibrate the microphone 114 by generating sound that is transmitted by the speaker 120 and received by the sound level meter 118 and the microphone 122. The sound received at the microphone 122 and sound level meter 118 is analyzed and the calibration data 112 for the microphone 114 is generated and sent with the microphone 114 to the client 106. The calibration module 116 in some embodiments is implemented by a general purpose computing device (e.g., personal computer, laptop, PDA, cellular handset) that is configured utilizing software and/or firmware to capture and analyze the sound transmitted from the speaker 120.

Advantageously, the calibration data 112 generated by the calibration module 116 according to several embodiments of the present invention allows inexpensive and readily available microphones to be utilized in connection with sound analysis techniques that previously required substantially more expensive equipment. As discussed further herein, the calibration data 112 in some embodiments is encoded calibration data (e.g., to reduce its size) and in other embodiments, the calibration data 112 is raw calibration data.

The client 106 in this embodiment includes a speech-analysis unit 124, a feedback unit 126 and a data collection unit 128, which in several embodiments, are realized by a general purpose computing device (e.g., personal computer, laptop, PDA, cellular handset) that is configured utilizing software and/or firmware. The speech-analysis unit 124 in this embodiment is configured to receive the calibration data 112 and to operably couple with the microphone 114 so as to receive and analyze speech from a user utilizing the calibration data 112 and provide information about one or more aspects of the user's speech.

The feedback module 126 is configured to provide feedback to the user using graphical displays and/or audible feedback to facilitate proper sampling and provide a therapeutic feedback system to help improve the speech of a user. The data collection module 128 is configured to collect speech data gathered in the form of one or more files that may be transmitted to the clinic for further analysis.

The clinic 108 in this embodiment includes a target-settings module 130, a feedback-options module 132 and an analysis module 134. The target-settings module 130 allows a clinician to customize and provide target settings to a particular client. For example, target sound pressure levels may be established by a clinician and sent via the network 110 to the client. Similarly, the feedback-options module 132 allows a clinician to select specific forms of feedback (e.g., specific graphical interfaces) and send the selected feedback forms to the feedback module 126 at the client 106 so that the user interfaces with the speech analysis module using feedback techniques tailored to the user by the clinician.

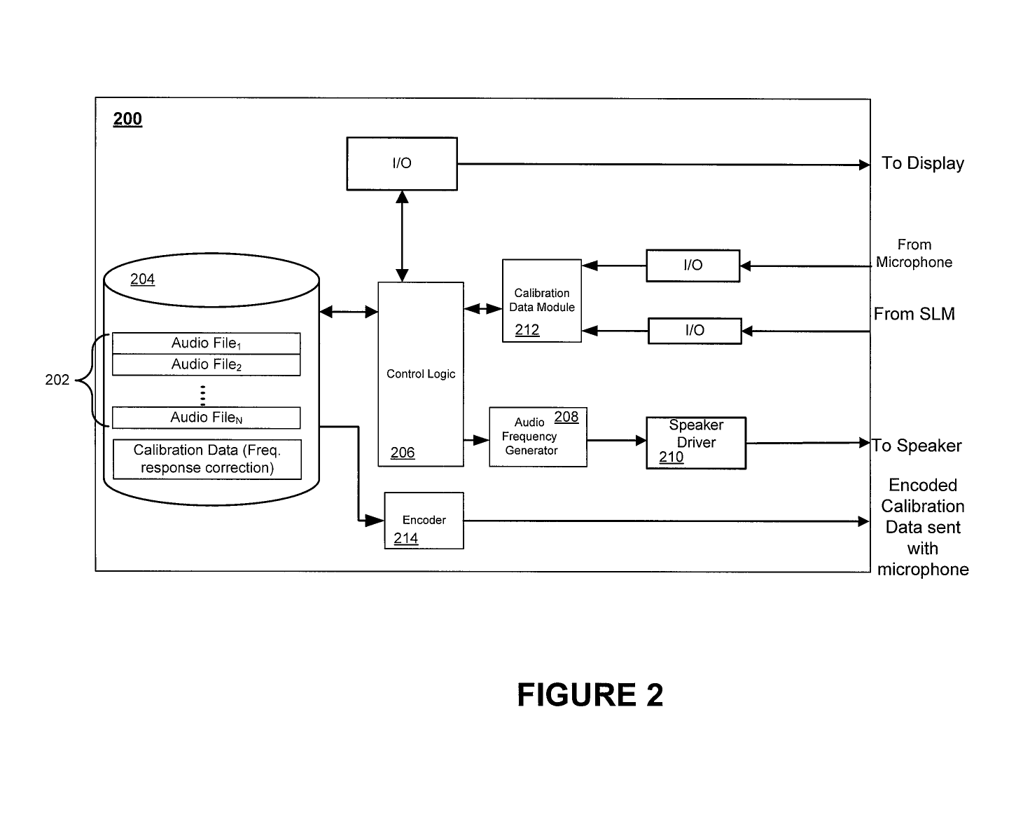

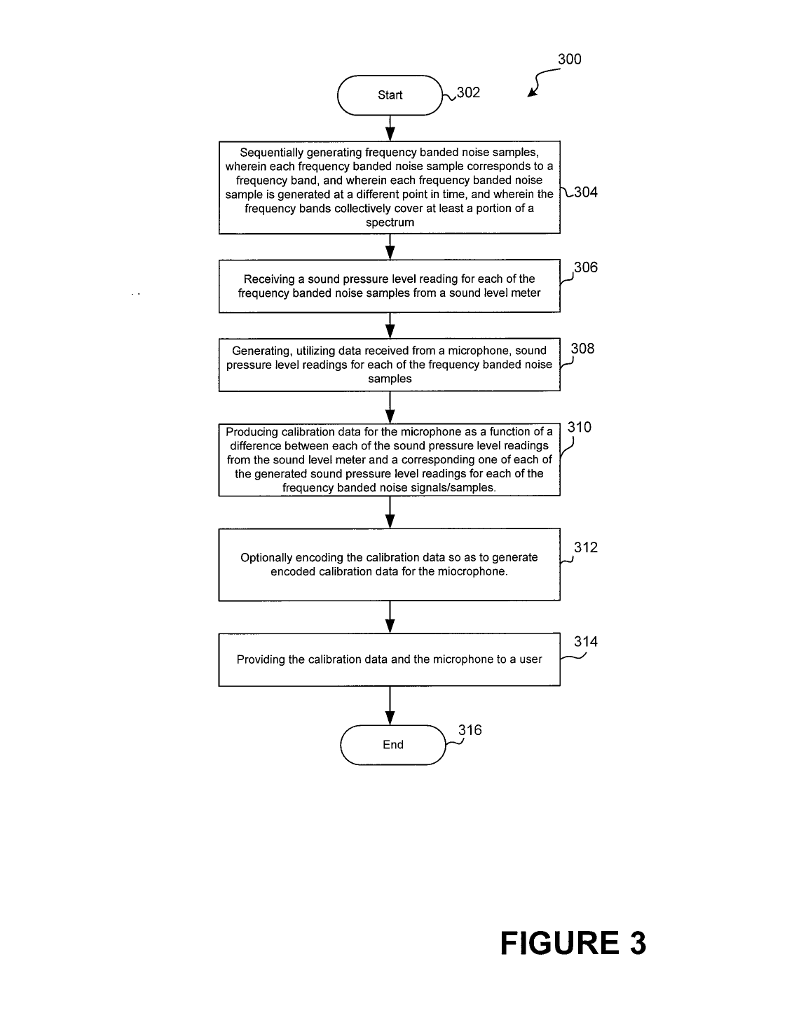

Referring next to FIG. 2. shown is a block diagram 200 of an exemplary embodiment of the calibration module 116 of FIG. 1. While referring to FIG. 2, simultaneous reference will be made to FIG. 3, which is a flowchart depicting steps traversed by the calibration module 116, 200 depicted in FIGS. 1 and 2.

As shown, the calibration module 200 initially generates frequency banded noise samples at different points in time (Blocks 302, 304). Each of the frequency banded noise samples in this embodiment corresponds to a different frequency band, and collectively the frequency bands cover at least a portion of a spectrum (e.g., a portion of an audible sound spectrum).

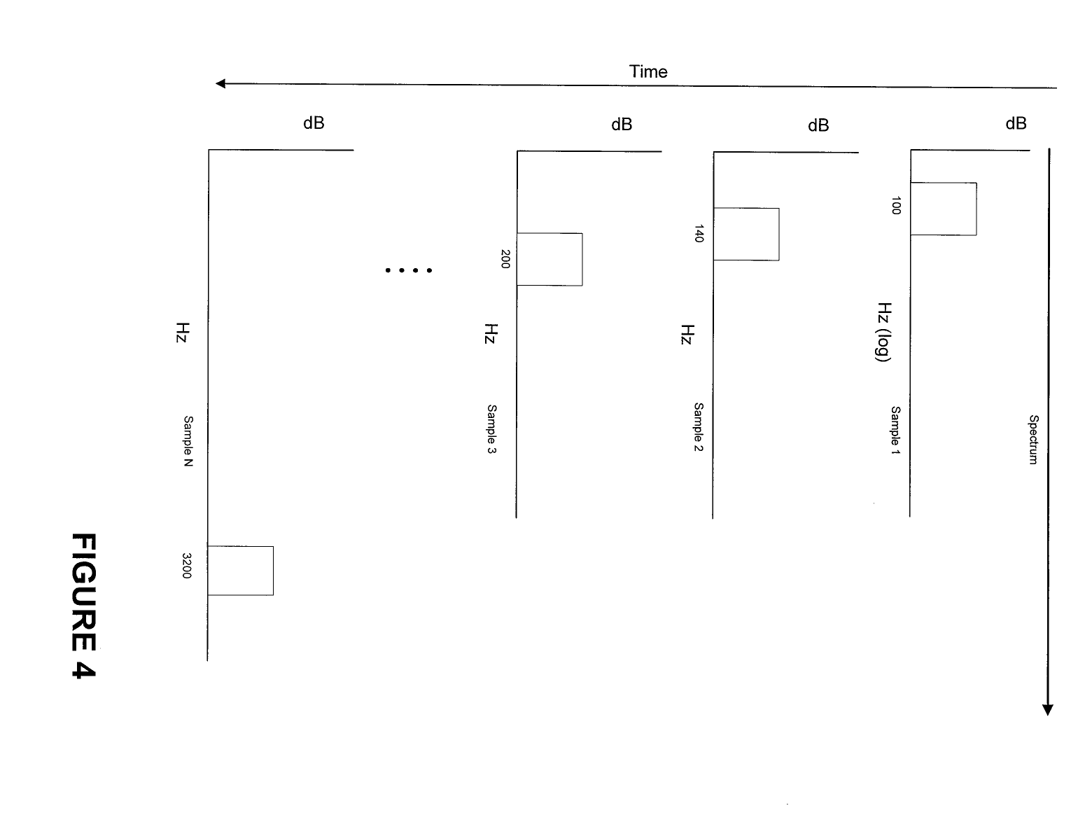

Referring to FIG. 4, for example, shown are N frequency banded noise samples that are generated sequentially one at a time in accordance with an exemplary embodiment. As shown, the noise samples are generated one at a time and each noise sample spans an octave band of a spectrum of noise (e.g., a spectrum of pink noise). In the exemplary embodiment, each successive banded noise sample overlaps a portion of the previous noise sample so that the entire spectrum is covered in a piecemeal fashion.

Referring back to the embodiment depicted in FIG. 2, each of N audio files 202 stored in a file storage device (e.g., a hard drive) 204 corresponds to, and includes data to generate, one of N frequency banded noise samples. Control logic 206, in connection with an audio frequency generator 208, is configured to sequentially retrieve each of the N audio files 202 and generate the frequency banded noise signals that are transduced from electrical energy to acoustical energy by the speaker 120 in connection with the speaker driver 210.

As shown, a sound-pressure-level reading for each of the frequency-banded-noise samples is received from the sound-level meter 118 (Block 306), and corresponding sound-pressure-level readings are generated for each of the frequency-banded-noise samples utilizing data received from the microphone 114 (Block 308). Next, calibration data 112 for the microphone 114 is produced by the calibration-data module 212 as a function of a difference between each of the sound-pressure-level readings from the sound level meter 118 and a corresponding one of each of the generated sound-pressure level readings for each of the frequency-banded-noise samples (Block 310). Optionally, calibration data is encoded by an encoder 214 so as to generate encoded-calibration data for the microphone 114 (Block 312), and then the calibration data 112 and the microphone 114 are provided to a user (Block 314). As depicted in FIG. 1, for example, the calibration data 112 is packaged along with the microphone 114 so that when the microphone 114 is received by a user, the user also possesses calibration data 112 that significantly improves sound readings from the microphone 114. This is certainly not required, however, and it is contemplated that the microphone 114 and calibration data 112 may be sent to the client at different times.

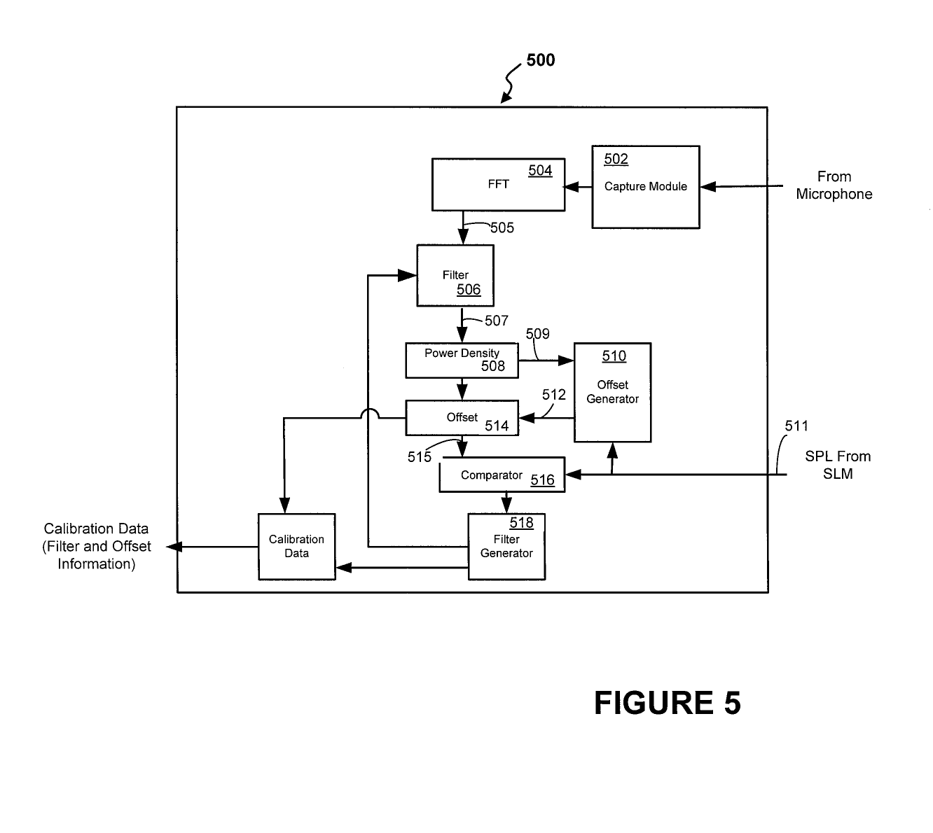

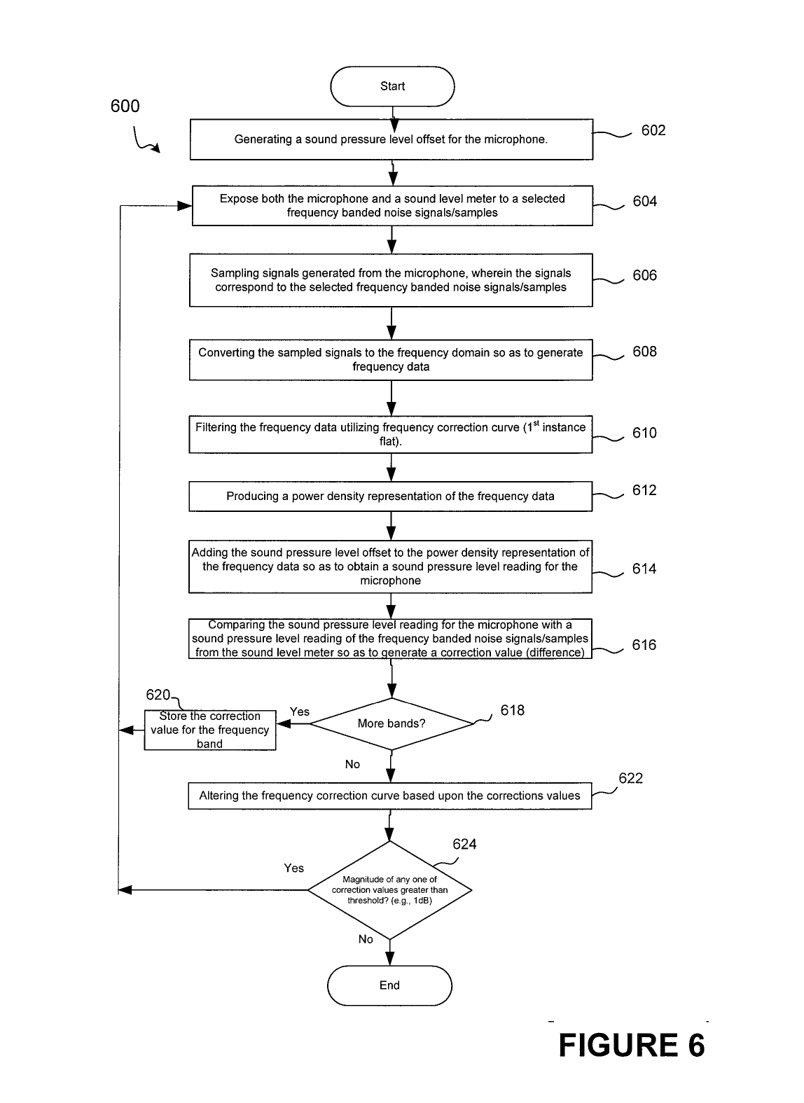

Referring next to FIG. 5, shown is a block diagram 500 depicting one embodiment of the calibration-data module 212 depicted in FIG. 2. While referring to FIG. 5, simultaneous reference will be made to FIG. 6, which depicts steps traversed by the calibration-data module 500 when generating calibration data. As shown, initially a sound-pressure-level offset for the microphone 114 is generated (Block 602).

In some embodiments, the sound-pressure-level offset is generated by capturing with a capture module 502 a noise sample (e.g., pink noise) received by the microphone 114 that is transduced by the speaker 120. The sampled noise is then converted to the frequency domain with the Fast Fourier Transform (FFT) module 504, and a power-density module 508 generates a power-density reading 509 from the noise represented in the frequency domain. An offset generator 510 then compares the power-density reading 509 with a sound-pressure reading 511 of the noise sample (obtained from the sound-level meter 118) to generate an offset 512 for the microphone.

In one embodiment, noise is generated with the speaker at several power levels (e.g., every 3 dB from 60 to 90 dB) and a reading at each of the power levels is obtained with the microphone 114 and compared against the sound-pressure readings from the sound-level meter 118 so as to arrive at an accurate offset over a range of power levels.

Once the sound pressure level offset for the microphone 114 is generated, both the microphone 114 and the sound-level meter 118 are exposed to a selected frequency banded noise sample (Block 604). In some embodiments, for example, a frequency banded pink noise sample that corresponds to a frequency band from 100 to 200 Hz is initially generated and transduced by the speaker so as to expose the microphone and sound level meter to the noise sample with frequencies from 100 to 200 Hz.

Once the microphone 114 is exposed to the frequency-banded-noise sample, signals generated from the microphone 114 are sampled by the capture module 502 (Block 606), and converted by the FFT module 504 to the frequency domain so as to generate frequency data 505 (Block 608). The frequency data 505 is then filtered by the filter module 506 so as to obtain filtered frequency data 507 (Block 610). For the first frequency-banded sample, the filter module 506 employs a flat-frequency-response filter, but subsequent frequency-banded samples are filtered utilizing a response curve generated as a function of the microphone's 114 response to previous noise banded sample(s).

As shown in FIGS. 5 and 6, after filtering, a power-density representation of the frequency data is produced by the power-density module 508 (Block 612), and the sound pressure level offset 514 is added to the power-density representation of the frequency data so as to obtain a sound-pressure level reading 515 for the microphone (Block 614). A comparator 516 then compares the sound-pressure reading 515 for the microphone 114 with a sound-pressure level reading of the frequency banded noise signals/sample from the sound level meter 118 so as to generate a correction value (e.g., a difference) (Block 616).

If there are more frequency bands to sample with the microphone (Block 618), then the correction value for the frequency band is stored and blocks 604-616 are executed again. If there are no more frequency bands to sample (Block 618), then the frequency-correction curve is altered by the filter generator 518 based upon the correction values. In the event the magnitude of any one of correction values is greater than a threshold, (e.g., 1 dB), then data for the frequency correction curve is stored along with the correction value (Block 620) and blocks 604-622 are executed again. If the magnitude of all the correction values is less than the threshold, however, the correction values are stored along with the sound pressure level offset.

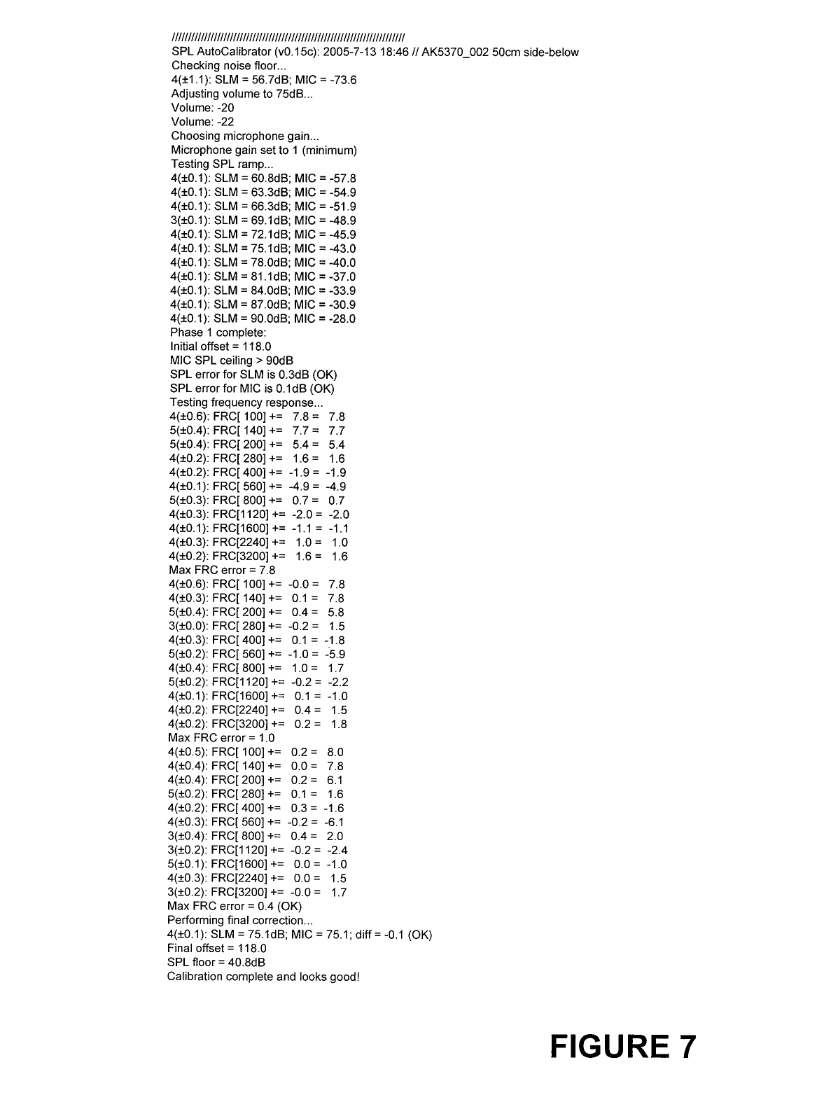

FIG. 7 depicts a sample calibration log depicting data generated from the process described with reference to FIG. 6. As shown in FIG. 7, data relating to the generation of the sound pressure offset includes eleven measurements for sound levels ranging from 60.8 dB to 90.0 dB and an initial offset of 118.0. Also shown is data that includes frequency response data for three iterations of Blocks 602-624. As depicted in FIG. 7, after the third iteration, the FRC error (i.e., 0.4 dB) is less than 1 dB, which indicates the calibration is complete.

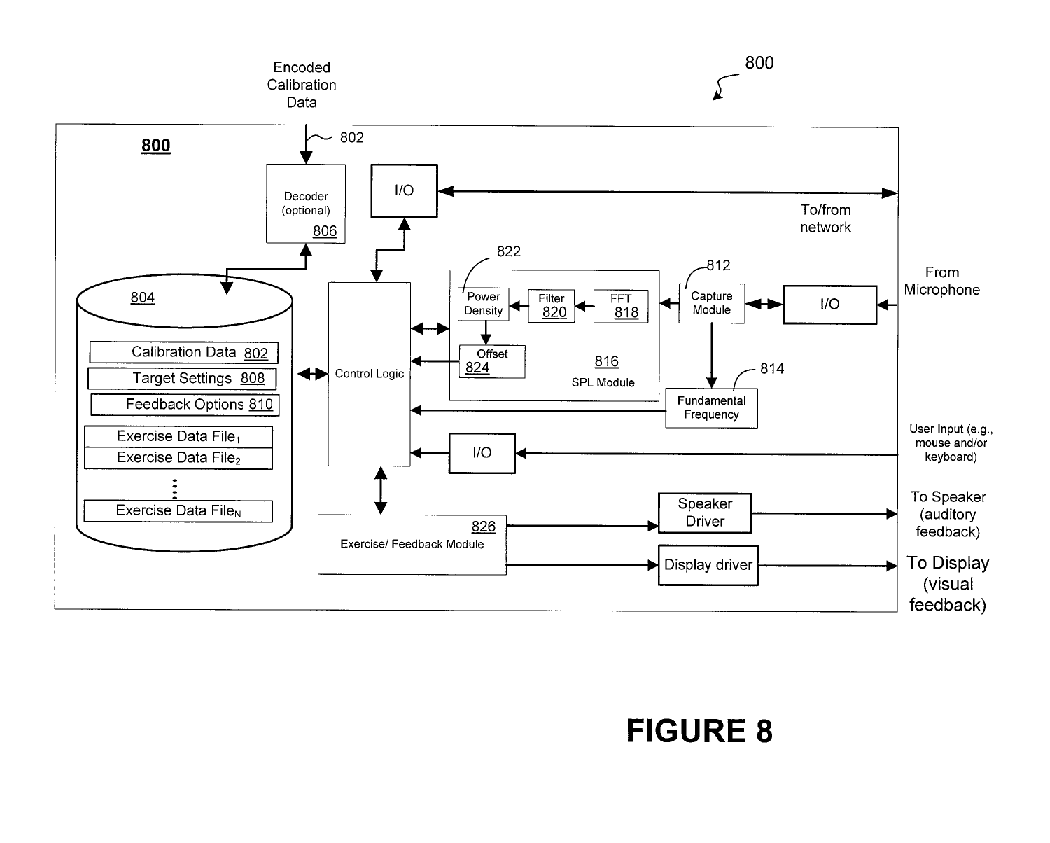

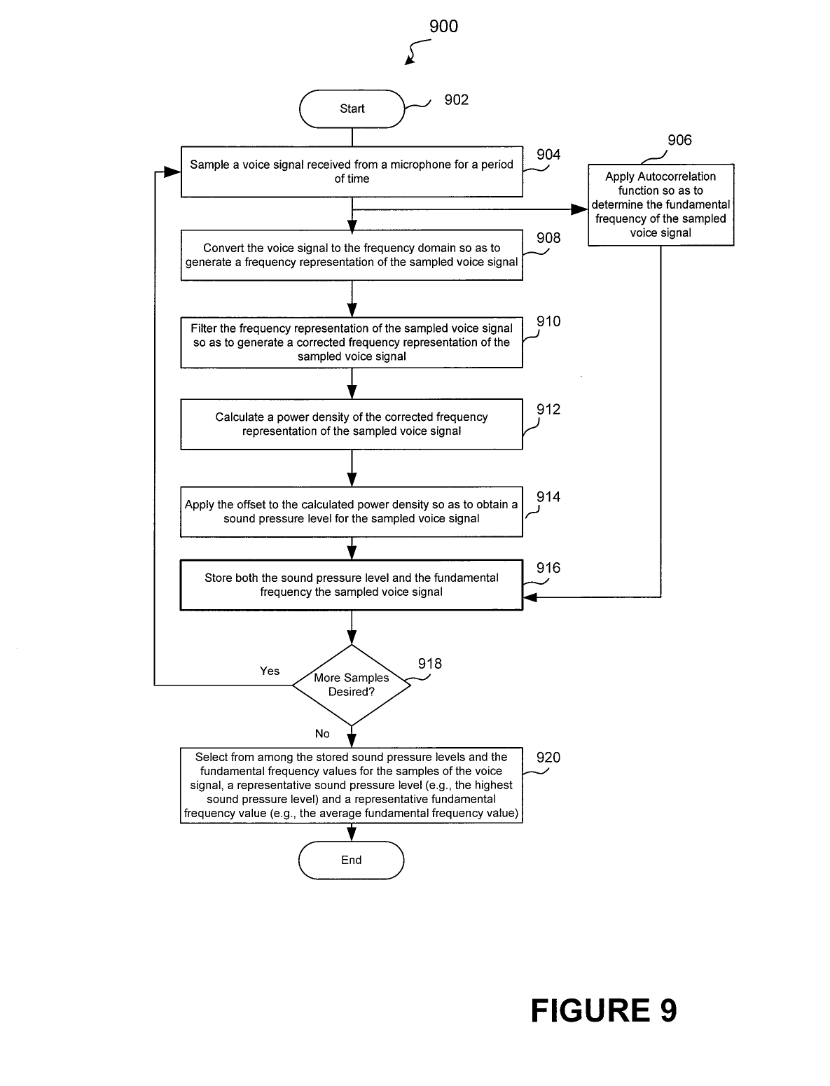

Referring next to FIG. 8, shown is a block diagram 800 of one embodiment of the data collection 128, feedback 126 and speech analysis 124 blocks depicted in FIG. 1. While referring to FIG. 8, simultaneous reference will be made to FIG. 9, which is a flowchart depicting steps traversed by the speech analysis module of FIG. 8 in accordance with an exemplary embodiment. As shown in FIG. 8, calibration data 802 is received (e.g., entered by a user or received via the network depicted in FIG. 1) and stored in a storage device 804 that is associated with a particular microphone. An optional decoder 806 is depicted in FIG. 8, which is configured to generate decoded calibration data in the event the calibration data is encoded.

Also shown in the storage device 804 are target settings 808 that are utilized to set values utilized in speech therapy exercises. In addition, feedback options 810 that set the type of feedback that is employed during speech therapy sessions is also depicted in the storage device 804. In some embodiments, the target settings 808 and/or the feedback options 810 are established by a speech therapy clinician (e.g., at a remote clinical setting) and sent to the client.

As shown in FIG. 9, when a speech therapy session is initiated, a voice signal from a user is received at the microphone 114 and is sampled by the capture module 812 (Blocks 902, 904). In the exemplary embodiment, a fundamental frequency module 814 receives the sampled signal in the time domain and applies an autocorrelation function to obtain the fundamental frequency of the sampled voice signal (Block 906). In addition, the sampled voice signal is received by a sound pressure level module 816 and converted to the frequency domain by an FFT module 818 so as to generate a frequency representation of the sampled voice signal (Block 908).

As depicted in FIGS. 8 and 9, the frequency representation of the voice signal is then filtered by a filter 820 utilizing the calibration data so as to obtain a corrected voice signal (Block 910). A power density of the corrected voice signal (in the frequency domain) is then calculated by a power-density module 822 (Block 912), and a sound pressure level offset 824 (e.g., the sound pressure level offset obtained at Block 602) is applied to the power density to obtain a sound pressure level for the sampled voice signal (Block 914). Both the sound pressure level and the fundamental frequency of the sampled voice signal are then stored (Block 916).

If more samples of the user's voice are desired (Block 918), then Blocks 904 to 916 are traversed again. As depicted in FIG. 9, the highest sound pressure level among the samples is selected as the stored sound pressure level reading and an average value of the fundamental frequency is selected as the fundamental frequency. In some embodiments for example, five separate samples (e.g., 200 ms samples) are taken over the course of one second and the highest sound pressure level among the five samples is selected as the stored sound pressure level reading and an average value of the fundamental frequency is selected as the fundamental frequency.

As shown in FIG. 8, the sound pressure level readings and/or average values of the user's fundamental frequency may be stored in N exercise-data files (e.g., one or more data files), that may be analyzed at the client location 106 or sent to the clinic 108 for further analysis.

The exercise/feedback module 826 may be configured to provide exercises (e.g., video exercises) that prompt a user to perform particular speech exercises (e.g., vocalizing at various frequencies or speaking functional phrases) and may provide feedback (e.g., graphical or audible) to facilitate proper sampling and provide a therapeutic feedback system to help improve the speech of a user.

In many embodiments, the sound-pressure module 816 may be realized by a dynamic link library (DLL) module that may be seamlessly imported by a variety of software applications to utilize generated calibration data to substantially improve the quality sound measurements.

Although several embodiments of the present invention are described herein in the context of a speech therapy environment, it is certainly contemplated that the techniques for calibrating a transducer (e.g., a microphone) described herein have applications in a variety of contexts where sound analysis and/or feedback systems, outside of the therapy environment, is useful.

In conclusion, the present invention provides, among other things, a system and method for accurately measuring sound. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for measuring sound comprising:
sequentially generating frequency-banded-noise samples, wherein each frequency-banded-noise sample corresponds to a frequency band, each frequency banded noise sample being generated at a different point in time, wherein the frequency bands collectively cover at least a portion of a spectrum;
receiving a baseline sound-pressure-level reading for each of the frequency banded noise samples;
generating, utilizing data received from a microphone, a sound pressure level reading for each of the frequency banded noise samples;
producing calibration data for the microphone as a function of a difference between each of the baseline sound-pressure-level readings and a corresponding one of each of the generated sound pressure level readings for each of the frequency banded noise samples; and
providing the calibration data and the microphone to a user.

2. The method of claim 1, wherein the providing includes providing the calibration data and the microphone simultaneously to a user.

3. The method of claim 1, wherein the providing includes providing the calibration data to the user subsequent to the user receiving the microphone.

4. The method of claim 3, wherein the providing includes providing the calibration data to the user via the Internet.

5. The method of claim 1, including:
encoding the calibration data so as to generate encoded calibration data for the microphone.

6. The method of claim 1, wherein each of the frequency-banded-noise samples spans an octave band of a spectrum of noise.

7. The method of claim 6, wherein each of the frequency-banded-noise samples spans an octave band of a spectrum of pink noise.

8. The method of claim 1, including:
generating an offset for the microphone based upon a difference between the power-density reading of a noise sample received from the microphone with a sound-pressure reading of the noise sample received from a sound-level meter;
wherein producing calibration data includes producing the calibration data so as to include the offset.

9. A system for measuring sound, comprising:
a first input configured to receive a sound-pressure-level reading for each of a plurality of frequency-banded-noise samples, each of the frequency-banded-noise samples corresponding to a frequency band, and each of the frequency banded noise samples being generated at a different point in time, wherein the frequency bands collectively cover at least a portion of a spectrum;
a second input configured to receive, from a microphone, data corresponding to each of the plurality of frequency banded noise samples; and
a calibration module configured to generate calibration data for the microphone as a function of a difference between each of the sound-pressure-level readings received via the first input and a corresponding one of each of a plurality of generated-sound-pressure-level readings, the plurality of generated-sound-pressure-level readings being generated from the data corresponding to each of the plurality of frequency-banded-noise samples received from the second input.

10. The system of claim 9, wherein the calibration module is configured to generate the frequency-banded-noise samples.

11. The system of claim 10, wherein the calibration module includes a memory, the memory including at least one audio data file encoded with frequency-banded-noise data.

12. The system of claim 11, wherein the memory is selected from the group consisting of a hard drive, random-access memory and read-only memory.

13. The system of claim 9, wherein the calibration module is configured to encode the calibration data.

14. The system of claim 9, wherein the calibration module is configured to generate an offset for the microphone based upon a difference between the power-density reading of a noise sample received from the microphone with a sound-pressure reading of the noise sample received from a sound-level meter, wherein the calibration module is configured to include the offset as a component of the calibration data.

15. A processor-readable medium encoded with instructions for measuring sound, the instructions including instructions for:
sequentially generating frequency-banded-noise samples, wherein each frequency-banded-noise samples corresponds to a frequency band, each frequency banded noise sample being generated at a different point in time, wherein the frequency bands collectively cover at least a portion of a spectrum;
receiving a baseline sound-pressure-level reading for each of the frequency banded noise samples;
generating, utilizing data received from a microphone, a sound pressure level reading for each of the frequency banded noise samples; and
producing calibration data for the microphone as a function of a difference between each of the baseline sound-pressure-level readings and a corresponding one of each of the generated sound pressure level readings for each of the frequency banded noise samples.

16. The processor-readable medium of claim 15, wherein the instructions include instructions for providing the calibration data to a user, via the Internet, subsequent to the user receiving the microphone.

17. The processor-readable medium of claim 15, including instructions for:
encoding the calibration data so as to generate encoded calibration data for the microphone.

18. The processor-readable medium of claim 15, wherein each of the frequency-banded-noise samples spans an octave band of a spectrum of noise.

19. The processor-readable medium of claim 18, wherein each of the frequency-banded-noise samples spans an octave band of a spectrum of pink noise.

20. The processor-readable medium of claim 15, including instructions for:
generating an offset for the microphone based upon a difference between the power-density reading of a noise sample received from the microphone with a sound-pressure reading of the noise sample received from a sound-level meter;
wherein producing calibration data includes producing the calibration data so as to include the offset.

21. A processor-readable medium encoded with instructions for measuring sound, the instructions including instructions for:
converting a sound sample from a microphone into a frequency domain so as to generate frequency information relative to the sound sample;
filtering the frequency information with calibration data for the microphone, the calibration data including data dependent upon a difference between each of a plurality of baseline sound-pressure-level readings and a corresponding one of each of a plurality of generated sound pressure level readings for each of a plurality of frequency banded noise samples;
generating a power density for the filtered frequency information so as to obtain a corrected sound sample; and
applying a sound-pressure level offset to the power density so as to obtain a sound-pressure level for the sound sample.

22. The processor-readable medium of claim 21, wherein the instructions include instructions for dynamically linking with a software application, wherein the software application is adapted to utilize the sound-pressure levels.
